(19) United States
(12) Patent Application Publication
(10) Pub. No.: US 2024/0193925 A1
(43) Pub. Date: Jun. 13, 2024

(54) IMAGE PROCESSING METHODS

(71) Applicant: Orbio Earth GmbH, Koln (DE)

(72) Inventors: Rozanne Mouton, De Velde Strand (ZA); William Kingwill, Western Cape (ZA); Wojciech Adamczyk, Opole (PL); Etienne Corminboeuf, Zurich (CH); Robert Huppertz, Bergisch Gladbach (DE)

(73) Assignee: Orbio Earth GmbH, Koln (DE)

(21) Appl. No.: 18/536,608

(22) Filed: Dec. 12, 2023

(30) Foreign Application Priority Data
Dec. 13, 2022 (DE) 10 2022 133 147.4

(51) Int. Cl. G06V 10/80; G06V 10/60; G06V 20/10; G06V 20/13

(52) U.S. Cl. CPC G06V 10/80; G06V 10/60; G06V 20/13; G06V 20/194

(57) ABSTRACT

An image processing method includes receiving satellite imagery corresponding to an area of the Earth and to a plurality of waveband channels having a first waveband. The satellite imagery includes a first top of atmosphere spectral reflectance image corresponding to the first waveband. The method further includes receiving methane plume data is received having a concentration corresponding to each pixel of the satellite images. A first synthetic transmittance image is calculated corresponding to the first waveband, based on the methane plume data, an absorbance of methane in the first waveband and a spectral response function of the satellite in the first waveband. A first output synthetic image is generated by combining the first synthetic transmittance image with the first top of atmosphere spectral reflectance image. The first output synthetic image is subsequently output or stored.

### CROSS-REFERENCE TO RELATED APPLICATIONS

This application claims the benefit and priority of German Application No. 10 2022 133 147.4 filed on Dec. 13, 2022. The entire disclosure of the above application is incorporated herein by reference.

### SUMMARY

According to a first aspect of the invention, there is provided a method including receiving satellite imagery corresponding to an area of the Earth and to a number of waveband channels. The number of waveband channels include a first waveband. The satellite imagery includes a first top of atmosphere spectral reflectance image corresponding to the first waveband. The method also includes receiving methane plume data comprising a excessive methane column concentration corresponding to each pixel of the satellite images. The method also includes calculating a first synthetic transmittance image corresponding to the first waveband, based on the methane plume data, an absorbance of methane in the first waveband and a spectral response function of the satellite in the first waveband. The method also includes generating a first output synthetic image by combining the first synthetic transmittance image with the first top of atmosphere spectral reflectance image. The method also includes outputting or storing the first output synthetic image.

Receiving methane plume data may mean retrieval from a storage device. The methane plume data may be measured. The methane plume data may be simulated/synthetic.

The satellite imagery may also include bottom of atmosphere spectral reflectance images corresponding to each of the number of wavebands. The method may also include determining a land cover map corresponding to the area based on comparing the bottom of atmosphere spectral reflectance images to a reference spectral library. Combining the first synthetic transmittance image with the first top of atmosphere spectral reflectance image may include correcting the first synthetic transmittance image based on the land cover map, and pixelwise combining the corrected first synthetic transmittance image and the first top of atmosphere spectral reflectance image.

Bottom of atmosphere spectral reflectance images may alternatively be termed “ground spectral reflectance” images.

Combining the first synthetic transmittance image with the first top of atmosphere spectral reflectance image may additionally or alternatively include correcting the first synthetic transmittance image based on an angle of illumination corresponding to the satellite imagery, and pixelwise multiplying (combining) the corrected first synthetic transmittance image and the first top of atmosphere spectral reflectance image. The angle of illumination may be determined based on a date and time corresponding to the satellite imagery, combined with a latitude and longitude of the area.

The method may also include receiving background concentrations of one or more of methane, water and carbon dioxide. Combining the first synthetic transmittance image with the first top of atmosphere spectral reflectance image may additionally or alternatively include correcting the first synthetic transmittance image based on the background concentrations and pixelwise multiplying (combining) the corrected first synthetic transmittance image and the first top of atmosphere spectral reflectance image.

Any or all of the corrections to the first synthetic transmittance image may be combined before pixelwise multiplying (combining) the corrected first synthetic transmittance image and the first top of atmosphere spectral reflectance image.

The method may also include adding synthetic noise to one or more of:
the methane plume data;
the first synthetic transmittance image; and/or
the first output synthetic image.

The synthetic noise may be Gaussian distributed about a mean of zero. The standard deviation of the synthetic noise may be calibrated based on the first top of atmosphere spectral reflectance image.

The number of waveband channels may include a second waveband different to the first waveband. The satellite imagery may also include a second top of atmosphere spectral reflectance image corresponding to the second waveband. The method may also include calculating a second synthetic transmittance image corresponding to the second waveband, based on the methane plume data, an absorbance of methane in the second waveband and a spectral response function of the satellite in the second waveband. The method may also include generating a second output synthetic image by combining the second synthetic transmittance image with the second top of atmosphere spectral reflectance image. When included the method of combining the second synthetic transmittance image with the second top of atmosphere spectral reflectance image is the same as the method used for combining the first synthetic transmittance image with the first top of atmosphere spectral reflectance image. The method may also include outputting or storing the second output synthetic image.

In an option, a ratio of signals in the first and second wavebands may correlate to methane concentration.

Calculating a first/second synthetic transmittance image may include, for the respective waveband:
calculating an absorbance as the pixel-wise dot product of the methane plume data and the wavelength dependent absorbance of methane in that waveband;
converting the absorbance to a transmittance; and/or
calculating the synthetic transmittance image as the pixel-wise dot product of the transmittance and the spectral response function of the satellite in that waveband.

The first waveband may include/span 2200 nm, or 3200 nm, and may have a bandwidth of no more than 200 nm.

The second waveband may not overlap the first waveband, may include/span 1612 nm, and may have a bandwidth of no more than 150 nm.

The satellite imagery may take the form of imagery from the European Space Agency Sentinel 2 constellation. The top of atmosphere reflectance images may take the form of 1C level Sentinel 2 data corresponding to bands B11 and/or B12. When used, the bottom of atmosphere spectral reflectance images may take the form of 2A level Sentinel 2 data corresponding to bands B1 to B12.

The satellite imagery may take the form of imagery from the United States Geological Survey/NASA Landsat-8 and/or Landsat-9 constellation. The top of atmosphere reflectance images may take the form of Landsat L1TP data corresponding to bands B7 and/or B6. When used, the bottom of atmosphere spectral reflectance images may take the form of Landsat L1TP data corresponding to bands B1 to B11.

Receiving methane plume data comprises generating the methane plume data based on an atmospheric simulation taking into account a mass flux rate of methane release, a wind velocity and an emission height. The atmospheric simulation may include, or take the form of, a computational fluid dynamics model. The atmospheric simulation may take into account any number of additional variables and/or parameters. The mass flux rate of methane release may be time varying. The wind velocity may be time varying.

As an option, the atmospheric simulation may include, or take the form of, a large eddy simulation.

According to a second aspect of the invention, there is provided a method of generating a synthetic dataset, including using the method of the first aspect to generate a number of output synthetic images. Each output synthetic image corresponding to a unique combination of area and methane plume data. The method also includes storing each of the plurality of output synthetic images and the corresponding methane plume data.

The synthetic dataset may be generated based only on first output synthetic images. The synthetic dataset may be generated based only on pairs of first and second output synthetic images.

The method of generating the synthetic dataset may include features corresponding to any features of the method of the first aspect. Definitions applicable to the method of the first aspect (or features thereof) may be equally applicable to the method of generating the synthetic dataset (or features thereof).

The methane plume data may be generated based on atmospheric simulations.

In an option, for each area, a time series of two or more output synthetic images may be generated corresponding to different times during the same atmospheric simulation.

In an option, provided in addition or alternatively, the synthetic dataset may also include a number of unmodified top of atmosphere reflectance images corresponding to the first waveband, and when used the second waveband.

A fraction of unmodified top of atmosphere reflectance images in the synthetic dataset may be 50% or more. A fraction of unmodified top of atmosphere reflectance images in the synthetic dataset may be 60% or more. A fraction of unmodified top of atmosphere reflectance images in the synthetic dataset may be 70% or more. A fraction of unmodified top of atmosphere reflectance images in the synthetic dataset may be 80% or more. A fraction of unmodified top of atmosphere reflectance images in the synthetic dataset may be 90% or more.

Unmodified top of atmosphere reflectance images may be associated with zero, or empty, methane plume data in the synthetic dataset.

According to a third aspect of the invention, there is provided a method of training a machine learning model to analyze methane in satellite imagery. The method includes receiving or retrieving a synthetic training set generated according the second aspect. The method also includes training the machine learning model to infer the presence of a methane plume, and if present one or more parameters selected from:
a boundary or mask of the methane plume;
mass flux rate of a source of the methane plume;
a location of the source of the methane plume;
a concentration map of excess methane; and/or
a map of differences in spectral response of the wavebands which are attributable to methane.

The machine learning model processes inputs including images from the synthetic training set corresponding to the first, and optionally second, wavebands. The training includes supervised learning with ground truths based on the corresponding methane plume data. The method also includes storing the weights forming the trained machine learning model.

The synthetic dataset may be generated based only on first output synthetic images. The synthetic dataset may be generated based only on pairs of first and second output synthetic images.

The method of training the machine learning model may include features corresponding to any features of the method of the first aspect and/or the method of generating the synthetic dataset. Definitions applicable to the method of the first aspect and/or the method of generating the synthetic dataset (or features thereof) may be equally applicable to the method of training the machine learning model (or features thereof).

The machine learning model may include, or take the form of, a convolutional neural network. The machine learning model may include, or take the form of, a U-net model. The machine learning model may include, or take the form of, a diffusion model. The machine learning model may include, or take the form of, a guided transformer network.

A loss function for training the machine learning model may include a term based on a mass difference between a first mass of methane calculated for the methane plume using the inferred outputs of the machine learning model, and a second mass of methane corresponding to the methane plume data.

The inputs to the machine learning model may include a time series of images from the synthetic training set, the time series corresponding to the same area.

According to a fourth aspect of the invention, there is provided a method of analyzing satellite imagery to identify methane plumes. The method includes receiving satellite imagery corresponding to an area of the Earth and to a number of waveband channels. The number of waveband channels include a first waveband. The satellite imagery includes one or more first top of atmosphere reflectance images corresponding to the first waveband. The method also includes applying a trained machine learning model to inputs including the one or more first top of atmosphere reflectance images to infer the presence of a methane plume, and if present one or more of parameters selected from:
a boundary or mask of the methane plume;
a mass flux rate of a source of the methane plume;
a location of the source of the methane plume;
a concentration map of excess methane; and/or
a map of differences in spectral response which are attributable to methane.

The method also includes, in response to the methane plume is detected, storing or outputting the one or more of parameters of the methane plume.

The method of analyzing satellite imagery may include features corresponding to any features of the method of the first aspect, the method of generating the synthetic dataset and/or the method of training the machine learning model. Definitions applicable to the method of the first aspect, the method of generating the synthetic dataset and/or the method of training the machine learning model (or features thereof) may be equally applicable to the method of analyzing satellite imagery (or features thereof).

The number of waveband channels may also include a second waveband different to the first waveband. The satellite imagery may also include one or more second top of atmosphere reflectance images corresponding to the second waveband. The inputs may include the one or more first top of atmosphere reflectance images and the one more second top of atmosphere reflectance images.

The method may also include, in response to the methane plume is detected, estimating a total mass of methane based on the one or more of parameters of the methane plume.

The machine learning model was trained using the method of the third aspect.

All methods defined herein for implementation using one or more computers.

According to a fifth aspect of the invention, there is provided a computer program product storing computer program code configured such that, when executed by one or more computer processors, carries out a method according to any one of the first to fourth aspects.

The computer program code may include, or take the form of, source code. The computer program code may include, or take the form of, compiled binaries. The computer program code may include, of take the form of bytecode or other intermediary formats for execution by a virtual machine.

According to a sixth aspect of the invention, there is provided apparatus configured to carry out a method according to any one of the first to fourth aspects.

It has to be noted that embodiments are described with reference to different subject-matters. In particular, some embodiments are described with reference to method-type claims (computer program) whereas other embodiments are described with reference to apparatus-type claims (system/device). However, a person skilled in the art will gather from the above and the following description that, unless otherwise specified, any combination of features belonging to one type of subject-matter as well as any combination between features relating to different subject-matters is considered to be disclosed with this application.

The aspects defined above and further aspects, features and advantages of the present invention can also be derived from the examples of the embodiments to be described hereinafter and are explained with reference to examples of embodiments also shown in the figures, but to which the invention is not limited.

### BRIEF DESCRIPTION OF DRAWINGS

FIG. 1 shows a schematic of the system described;

FIG. 2 shows a flow diagram of the method described;

FIG. 3A shows a 2D array representing an artificial methane plume, namely Plume 1: synthetic methane concentration (source rate: 10.000 kg/hr);

FIG. 3B shows a 2D array representing an artificial methane plume, namely Plume 2: synthetic methane concentration (source rate: 2.000 kg/hr);

FIG. 3C shows a 2D array representing an artificial methane plume, namely Plume 3: synthetic methane concentration (source rate: 7.500 kg/hr);

FIG. 3D shows a 2D array representing an artificial methane plume, namely Plume 4: synthetic methane concentration (source rate: 400 kg/hr);

FIG. 4A shows a 2D array representing B12 with synthetic methane signature inserted;

FIG. 4B shows a 2D array representing B11 with synthetic methane signature inserted;

FIG. 4C shows a 2D array representing ingested pixel-wise, synthetic methane concentration (source rate: 10.000 kg/hr); and

FIG. 4D shows a 2D array representing binary plume mask with source location (lat/lon: 500270/350813).

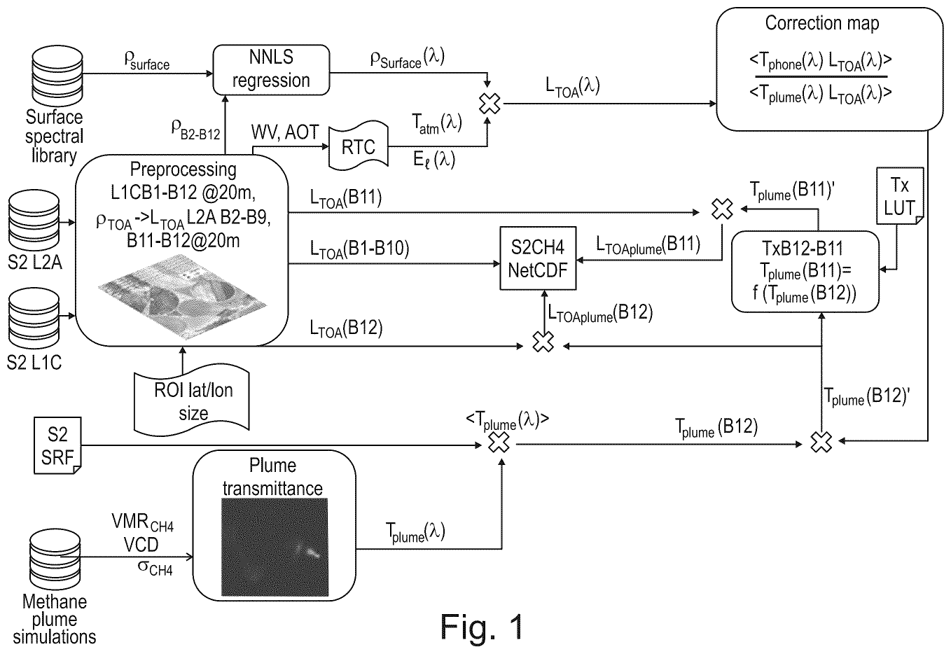

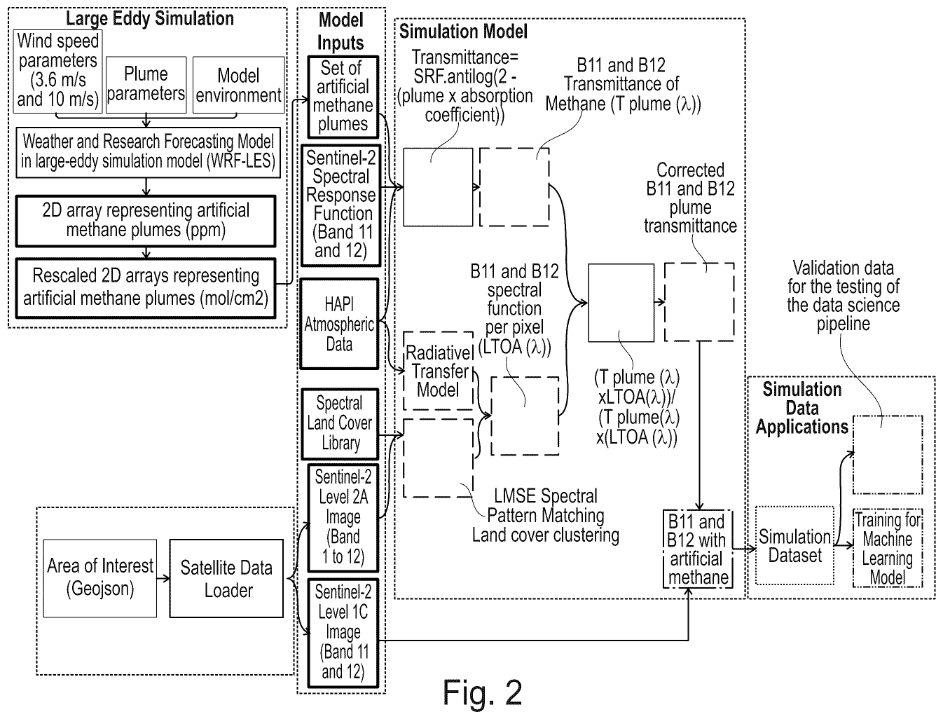

### DETAILED DESCRIPTION

The goal of the simulation pipeline is to insert an artificial methane signature of known quantity, size and shape into existing Sentinel-2 scenes. This data can then be used to test and train a variety of models.

### Step 1: Create the Artificial Methane Signature:

A large eddy simulation (LES) was used to generate 5 different plume shapes (each shape was created by choosing a different source location and random conditions), each run for a wind speed of 10 m/s and 3.6 m/s for a range of different flux rates (100 kg/h to 15 000 kg/h). The output was 272 different methane retrievals. These methane retrievals represent the vertical methane concentration of each pixel in ppm.
The methane retrievals are converted to mol/cm2, then a dot product in created with the retrievals and the absorption coefficients (as a function of wavelength) for the spectral range of B11 and B12. The output product represents the absorbance (as a function of wavelength) of each pixel for the B11 and B12 ranges respectively.
The absorbance is converted to transmittance and then a dot product is created with the spectral response function of B11 and B12 respectively. The final product represents the B11 and B12 transmittance of the retrievals.

### Step 2: Add Noise:

Using Sentinel level 2A imagery, a spectral land cover signature is created (for the wavelength range of B11 and B12) for each pixel. This is done, by selecting the spectral signature from a spectral library that is the closest match to the signature created with the Sentinel 2 level 2A bands.
This signature is put through a series of spectral filters that compensate for H2O, CO2, inherent CH4 in the atmosphere, as well as for angle of illumination. The output product represents realistic noise from surface albedo and the atmosphere.
The noise is added to the B11 and B12 transmittance using the correction factor in the diagram above.

### Step 3: Create the Final Product:

The B11 and B12 transmittance are multiplied by the B11 and B12 raw level 1C Sentinel-2 bands respectively. The output products are the B11 and B12 bands with the artificial methane signature inserted.

### Large Eddy Simulation:

Wind speed parameters: Plumes had to be created for a lower wind speed and a higher wind: 3.6 m/s and 10 m/s were selected.

Plume parameters: To create different realistic plumes, the source location of the plume was randomised (a random x and y were selected within the model area), creating 5 different plume shapes for each wind speed, resulting in 10 different plume shapes. A methane release rate of 100 kg/h was used. Emission height was 3m above the ground.

Model environment: The WRF-LES model has the option to create a real or ideal model, the real model uses a real location on earth and creates the simulation according to that location, the ideal model creates a generic simulation based on standardized conditions. The IDEAL model was used to create more generic plumes (so that they can be inserted into different satellite images). A 10 km by 10 km area was used, with a resolution of 20m.

Weather and Research Forecasting Model in large-eddy simulation model (WRF-LES): All the default parameters of the WRF-LES IDEAL model were used, except for the ones specified above.

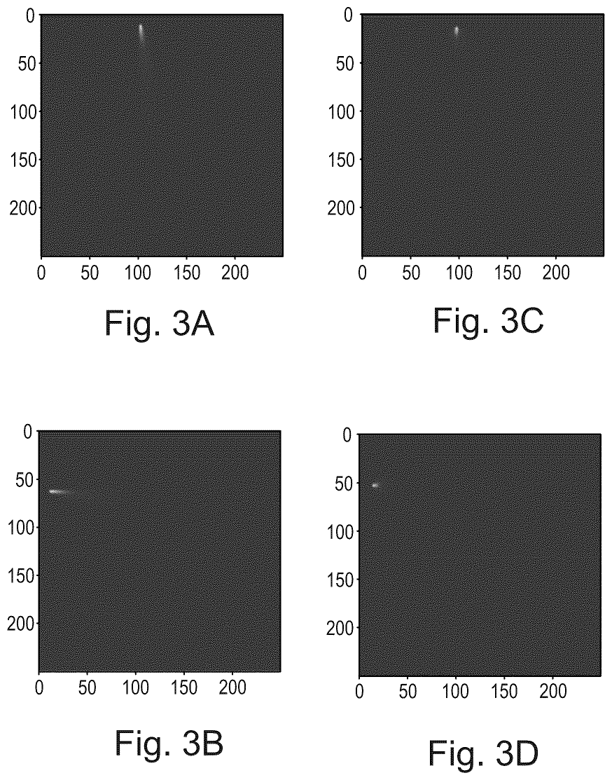

2D array representing artificial methane plumes (ppm): Ten 250 pixel by 250 pixel arrays are produced representing the methane plume creating by the simulated leak occurring for 2 hours. See, for example FIGS. 3A-3D.

Rescaled 2D arrays representing artificial methane plumes (mol/cm2): Rescale the values to represent flux rates from 100 kg/h to 15,000 kg/h: Output is 48 different 500 pixel by 500 pixel plume arrays. Arrays are then converted to mol/cm2.

Area of Interest: Create a geojson with the coordinates of the area on the ground for creating simulation data.

Satellite Data Loader: Create a geojson with the coordinates of the area on the ground for creating simulation data.

### Model Inputs:

### Set of Artificial Methane Plumes:

Sentinel-2 Spectral Response Function (Band 11 and 12): Table that relates electromagnetic wavelength to the sensitivity of the sensor for each satellite band. The diode for each band is sensitive to a specific range of wavelengths the spectral response function indicates the maximum reflectance that can be achieved for each wavelength in that range. The digital value recorded for each pixel for each band in the satellite image is the sum of each recorded reflectance of the band wavelength range.

HAPI Atmospheric Data: HAPI contains a range of atmospheric data, for the pipeline we need a table that relates wavelength to the % of absorption for methane, water vapor and carbon dioxide).

Spectral Land Cover Library: A table that records the reflectance for each wavelength of the electromagnetic spectrum (the portion that is useable for remote sensing) for different types of land cover. Each object on the ground interacts with the electromagnetic energy produced by the sun in a unique way and produces a unique reflectance pattern.

Sentinel-2 Level 2A Image (Band 1 to 12): Sentinel image with all bands. (Level 2A means that the image has undergone multiple preprocessing steps, including atmospheric correction and geometric correction and now represents the ground reflectance).

Sentinel-2 Level 1C Image (Band 11 and 12): Sentinel image with all bands. (Level 1C means that the image has undergone multiple preprocessing steps, including geometric correction and now represents the top of atmosphere reflectance).

### Simulation Model:

Transmittance=SRF.antilog (2−(plume×absorption coefficient)): When you multiply the simulated methane plume array (mol/cm2) by the absorption coefficient of methane (cm2/mol), you get the absorption of methane as a function of wavelength. Absorption can be converted to transmittance using (1−antilog(absorption)). The spectral response function (SRF) represents the maximum reflectance recorded by the satellite for each wavelength in the specific band we are looking at). Multiplying the transmittance by the SRF we remove the portion of the reflectance that would have been absorbed had the electromagnetic energy encountered the methane in the simulation. The end product is a 500×500×(range of wavelength) array representing the transmittance for the Sentinel-2 band after encountering the methane as a function of wavelength.

B11 and B12 Transmittance of Methane (T plume (A))

### Radiative Transfer Model:

LMSE Spectral Pattern Matching Land cover clustering: Compare the spectral response of each band to the spectral response of each land cover in the spectral library, choose the land cover with the smallest least mean square error (LMSE).

B11 and B12 spectral function per pixel (LTOA (A)): Use the radiative transfer model to change the signature of the selected land cover for each pixel to compensate for the effect of inherent methane, water vapor and carbon dioxide in the atmosphere. Also compensate for the angle of illumination electromagnetic energy. The end product is a 500×500×wavelength range of band array that represents the top of atmosphere reflectance as a function of wavelength.

(T plume (λ)×LTOA(λ))/(T plume (λ))×(LTOA (λ)): Normalize the reflectance of the plume to compensate for the effect of the land cover and atmosphere (contained in the top of atmosphere array).

Corrected B11 and B12 plume transmittance: Final product represents corrected reflectance of simulated plume for B11 and B12.

B11 and B12 with artificial methane: Multiply the corrected transmittance with the Level 1C Sentinel 2 image to create the simulated S2 product.

### Simulation Data Applications:

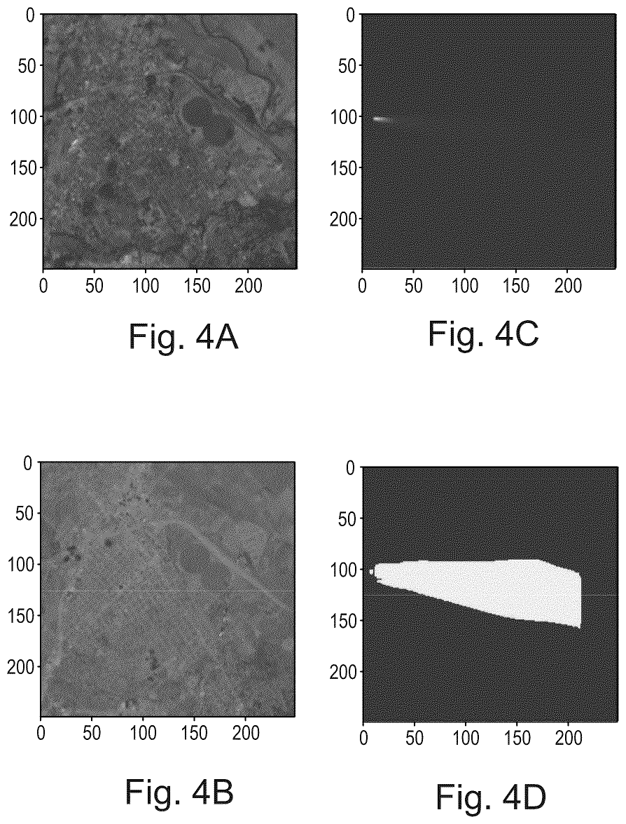

Simulation Dataset: B11 and B12 (GeoTIFF) (10 km×10 km and 20m resolution) with methane signature inserted. See, for example FIGS. 4A and 4B. Additional data includes a binary mask showing the location of the plume (numpy array), json file with the lat lon of the plume source and the emission rate of the plume). See, for example FIGS. 4C and 4D.

Validation data for the testing of the data science pipeline.

Training for Machine Learning Model.

1. A method comprising:
receiving satellite imagery corresponding to an area of the Earth and to a plurality of waveband channels, wherein the plurality of waveband channels comprise a first waveband, the satellite imagery including a first top of atmosphere spectral reflectance image corresponding to the first waveband;
receiving methane plume data including a concentration corresponding to each pixel of the satellite images;
calculating a first synthetic transmittance image corresponding to the first waveband, based on the methane plume data, an absorbance of methane in the first waveband and a spectral response function of the satellite in the first waveband;
generating a first output synthetic image by combining the first synthetic transmittance image with the first top of atmosphere spectral reflectance image; and
outputting the first output synthetic image.

2. The method of claim 1, wherein the satellite imagery further comprises bottom of atmosphere spectral reflectance images corresponding to the plurality of wavebands, the method further comprising:
determining a land cover map corresponding to the area based on comparing the bottom of atmosphere spectral reflectance images to a reference spectral library;
wherein combining the first synthetic transmittance image with the first top of atmosphere spectral reflectance image includes:
correcting the first synthetic transmittance image based on the land cover map; and
pixelwise multiplying the corrected first synthetic transmittance image and the first top of atmosphere spectral reflectance image.

3. The method of claim 1, wherein combining the first synthetic transmittance image with the first top of atmosphere spectral reflectance image comprises:
correcting the first synthetic transmittance image based on an angle of illumination corresponding to the satellite imagery; and
pixelwise multiplying the corrected first synthetic transmittance image and the first top of atmosphere spectral reflectance image.

4. The method of claim 1, further comprising at least one of the steps of:
i) receiving background concentrations of one or more of methane, water and carbon dioxide;
wherein combining the first synthetic transmittance image with the first top of atmosphere spectral reflectance image includes:
correcting the first synthetic transmittance image based on the background concentrations;
pixelwise multiplying the corrected first synthetic transmittance image and the first top of atmosphere spectral reflectance image; and
adding synthetic noise to one or more of methane plume data, the first synthetic transmittance image, and the first output synthetic image.

5. The method of claim 1, wherein the plurality of waveband channels comprises a second waveband different to the first waveband and the satellite imagery further comprises a second top of atmosphere spectral reflectance image corresponding to the second waveband, the method further comprising:
calculating a second synthetic transmittance image corresponding to the second waveband, based on the methane plume data, an absorbance of methane in the second waveband and a spectral response function of the satellite in the second waveband;
generating a second output synthetic image by combining the second synthetic transmittance image with the second top of atmosphere spectral reflectance image, wherein the method of combining the second synthetic transmittance image with the second top of atmosphere spectral reflectance image is the same as the method used for combining the first synthetic transmittance image with the first top of atmosphere spectral reflectance image; and
outputting or storing the second output synthetic image;
wherein a ratio of signals in the first and second wavebands correlates to methane concentration.

6. The method of claim 1, wherein calculating a synthetic transmittance images comprises, for the respective waveband:
calculating an absorbance as the pixel-wise dot product of the methane plume data and the wavelength dependent absorbance of methane in that waveband;
converting the absorbance to a transmittance; and
calculating the synthetic transmittance image as the pixel-wise dot product of the transmittance and the spectral response function of the satellite in that waveband.

7. The method of claim 1, wherein the first waveband comprises 2200 nm or 3300 nm and has a bandwidth of no more than 200 nm and the second waveband does not overlap the first waveband, comprises 1600 nm and has a bandwidth of no more than 150 nm.

8. The method of claim 1, wherein the satellite imagery takes the form of imagery from at least one of the group comprising:
i) the European Space Agency Sentinel 2 constellation, wherein the top of atmosphere reflectance images take the form of 1C level Sentinel 2 data corresponding to bands B11 and/or B12, and when used, the bottom of atmosphere spectral reflectance images take the form of 2A level Sentinel 2 data corresponding to bands B1 to B12; and
ii) the United States Geological Survey/NASA Landsat-8 and/or Landsat-9 constellation, wherein the top of atmosphere reflectance images take the form of Landsat L1TP data corresponding to bands B7 and/or B6, and when used, the bottom of atmosphere spectral reflectance images take the form of Landsat L1TP data corresponding to bands B1 to B12.

9. The method of claim 1, wherein receiving methane plume data comprises generating the methane plume data based on an atmospheric simulation taking into account a mass flux rate of methane release, a wind velocity and an emission height;
wherein the atmospheric simulation comprises a large eddy simulation.

10. A method of generating a synthetic dataset, comprising:
using the method of claim 1 to generate a plurality of output synthetic images, each output synthetic image corresponding to a unique combination of area and methane plume data;
storing each of the plurality of output synthetic images and the corresponding methane plume data.

11. The method of claim 10, wherein the methane plume data is generated based on atmospheric simulations;
wherein for each area, a time series of two or more output synthetic images is generated corresponding to different times during the same atmospheric simulation; and
wherein the synthetic dataset further comprises a plurality of unmodified top of atmosphere reflectance images corresponding to the first waveband, and when used the second waveband.

12. A method of training a machine learning model to analyze methane in satellite imagery, comprising:
receiving a synthetic training set generated according to claim 10;
training the machine learning model to infer the presence of a methane plume, and one or more parameters selected from:
a boundary or mask of the methane plume;
a mass flux rate of a source of the methane plume;
a location of the source of the methane plume;
a concentration map of excess methane; and
a map of differences in spectral response which are attributable to methane;
wherein the machine learning model processes inputs comprising images from the synthetic training set corresponding to the first, and optionally second, wavebands,
wherein the training comprises supervised learning with ground truths based on the corresponding methane plume data;
storing the weights comprising the trained machine learning model.

13. The method of claim 12, wherein a loss function for training the machine learning model comprises a term based on a mass difference between a first mass of methane calculated for the methane plume using the inferred outputs of the machine learning model, and a second mass of methane corresponding to the methane plume data.

14. The method of claim 12, wherein the inputs to the machine learning model comprise a time series of images from the synthetic training set, the time series corresponding to the same area.

15. A method of analyzing satellite imagery to identify methane plumes, comprising:
receiving satellite imagery corresponding to an area of the Earth and to a plurality of waveband channels, wherein the plurality of waveband channels comprise a first waveband, the satellite imagery comprising one or more first top of atmosphere reflectance images corresponding to the first waveband;
applying a trained machine learning model to inputs comprising the one or more first top of atmosphere reflectance images to infer the presence of a methane plume, and one or more of parameters selected from:
a boundary or mask of the methane plume;
a mass flux rate of a source of the methane plume;
a location of the source of the methane plume;
a concentration map of excess methane; and/or
a map of differences in spectral response which are attributable to methane;
in response to the methane plume being detected, outputting the one or more of parameters of the methane plume.

16. The method of claim 15, wherein the plurality of waveband channels comprise a second waveband different to the first waveband;
wherein the satellite imagery further comprises one or more second top of atmosphere reflectance images corresponding to the second waveband;
wherein the inputs comprise the one or more first top of atmosphere reflectance images and the one more second top of atmosphere reflectance images.

17. The method of claim 15, further comprising, in response to the methane plume being detected, estimating a total mass of methane based on the one or more of parameters of the methane plume.

18. The method of claim 15, wherein the machine learning model is trained to infer the presence of a methane plume, and one or more parameters selected from:
a boundary or mask of the methane plume;
a mass flux rate of a source of the methane plume;
a location of the source of the methane plume;
a concentration map of excess methane; and
a map of differences in spectral response which are attributable to methane;
wherein the machine learning model processes inputs comprising images from the synthetic training set corresponding to the first, and optionally second, wavebands,
wherein the training comprises supervised learning with ground truths based on the corresponding methane plume data;
storing the weights comprising the trained machine learning model.

19. A non-transitory computer-readable medium storing computer program code, which when executed by one or more computer processors, performs the method according to claim 1.

20. An image processor comprising one or more computer processors and memory storing computer program code, which when executed by the one or more computer processors performs the method according to claim 1.
